(19) United States
(12) Patent Application Publication
(10) Pub. No.: US 2006/0250934 A1
(43) Pub. Date: Nov. 9, 2006

(54) Three dimensional optical information carrier and a method of manufacturing thereof

(75) Inventors: David Livshits, Ashdod (IL); Yair Salomon, Jerusalem (IL); Ortal Alpert, Jerusalem (IL)

Correspondence Address: BROWDY AND NEIMARK, P.L.L.C.;624 NINTH STREET, NW, SUITE 300, WASHINGTON, DC, 20001-5303, US

(73) Assignee: MemPile Inc., Wilmington, DE (US)

(21) Appl. No.: 11/290,818

(22) Filed: Dec. 1, 2005

Related U.S. Application Data
(60) Provisional application No. 60/672,982, filed on Apr. 20, 2005.

(51) Int. Cl. G11B 7/24

(52) U.S. Cl. 369/275.1

(57) ABSTRACT

A three dimensional optical information carrier is presented. The information carrier comprises formatting marks disposed on the nodes of a three dimensional lattice formed by the intersection of equiangular spaced radial planes, equidistantly spaced cylindrical spiral tracks and virtual recording planes.

This application claims the benefit of and priority from U.S. provisional application No. 60/672,982, filed Apr. 20, 2005

### TECHNICAL FIELD

The three dimensional carrier and the manufacturing method relate to the field of optical information carriers used for recording, reading and erasing of information.

### BACKGROUND

Optical storage is one of the most popular information storage methods. The information is recorded, stored, read and erased on the three-dimensional storage media usually having the form of a disc. Carriers may be monolithic disc-like bodies made of a transparent or translucent polymer material or laminated of a number of plates made of the same material. The information is recorded on a carrier as series of three-dimensional (3D) regular marks or oblong and tilted data marks such as ones disclosed in Patent Convention Treaty Publication WO 2005/015552, to the same assignee as the present application. Each record of the 3D mark or voxel represents information, which may be a discrete 0 or 1.

Three-dimensional storage media has capacity of hundreds of Gigabytes, far exceeding the capacity of conventional discs. High recording and reading speeds are imperative for proper utilization of such media. However, high rotation speed introduces tracking difficulties associated among others with mechanical deformations caused by centrifugal forces.

Some optical discs have, in addition to information marks written on them, so called servo or formatting marks. Servo marks are embossed or optically recorded marks or symbols having a certain pattern that indicates the coordinates of the optical pick-up head relative to a nominal track. Knowledge of the coordinates allows synchronized or guided information recording, reading and erasing.

In a non-linear media and particularly two-photon media, laser beams of different wavelengths and power perform three dimensional storage media recording, reading and erasing processes. The guiding or servo beam may have a similar to the reading beam wavelength or a different wavelength. Proper information recording, reading and erasing require accurate determination of the laser beam location and appropriate laser power settings.

Known techniques of the kind specified are disclosed for example in U.S. Pat. Nos. 5,408,453 and 6,873,586. Additional reference may be the ECMA 317 standard.

### SUMMARY OF THE INVENTION

The present invention, in its one broad aspect, provides a three dimensional optical information carrier, comprising formatting marks disposed on the nodes of a three dimensional lattice formed by the intersection of equiangular spaced radial planes, equidistantly spaced cylindrical spiral tracks and virtual recording planes.

According to another broad aspect of the invention, there is provided a three dimensional optical information carrier having a body made of polymeric material, and comprising a reinforcing carcass supporting the body of the carrier, said carcass being made of material different from the body of the carrier and being an integral part of the carrier.

According to yet another broad aspect of the invention, there is provided a three dimensional optical information carrier having a body made of polymeric material, and comprising: a reinforcing carcass supporting the body of the carrier, said carcass being made of material different from the body of the carrier; and formatting marks made in the body of the carrier and being disposed on the nodes of a three dimensional lattice formed by the intersection of equiangular spaced radial planes, equidistantly spaced cylindrical spiral tracks and virtual recording planes.

According to yet another broad aspect of the invention, there is provided a three dimensional optical information carrier having a body made of polymeric material, and comprising: a central hub, which is made of material different from the body of the carrier, is an integral part of the carrier, and serves as the carrier mounting facility; and formatting marks made in the body of the carrier and being disposed on the nodes of a three dimensional lattice formed by the intersection of equiangular spaced radial planes, equidistantly spaced cylindrical spiral tracks and virtual recording planes.

In yet further broad aspect of the invention, there is provided a three dimensional multilayer optical information carrier comprising an assembly of plates containing an active moiety, the plates being attached to each other by an adhesive containing a proportion of active moiety different from the one contained in the plates.

According to yet further aspect of the invention, there is provided a three dimensional multilayer optical information carrier comprising an assembly of plates containing an active moiety, the plates being attached to each other by an adhesive containing a proportion of active moiety different from the one contained in the plates, and comprising a central hub made of material different from the body of the carrier and serving as the carrier mounting facility.

According to yet another aspect of the invention, there is provided a three dimensional multilayer optical information carrier comprising an assembly of plates containing an active moiety, the plates being attached to each other by an adhesive containing a proportion of active moiety different from the one contained in the plates, and comprising formatting marks made in the body of the carrier and being disposed on the nodes of a three dimensional lattice formed by the intersections of equiangular spaced radial planes, equidistantly spaced cylindrical spiral tracks and virtual recording planes.

According to yet another aspect of the invention, there is provided a three dimensional multilayer optical information carrier comprising: a body formed by an assembly of plates containing an active moiety, the plates being attached to each other by an adhesive containing a proportion of active moiety different from the one contained in the plates; and comprising a reinforcing carcass supporting the plates and being made of material different from the plates; and formatting marks made in the body of the carrier and being disposed on the nodes of a three dimensional lattice formed by the intersection of equiangular spaced radial planes, equidistantly spaced cylindrical spiral tracks and virtual recording planes.

The present invention, in its yet another broad aspect, provides a three dimensional optical information carrier, comprising a rotational axis and a polymeric body with bound to it active moiety, and comprising an enforcement carcass at least partially supporting the body, the body and the carcass being centered around said rotational axis.

According to yet further aspect of the invention, there is provided a three dimensional information carrier for information recording, comprising oblong and tilted, optically recorded formatting marks disposed on a three dimensional lattice nodes, the nodes being an intersection between equidistantly spaced spiral tracks, equiangular spaced radial planes and a plurality of recording planes, the recording planes being orthogonal to the radial planes.

Yet another broad aspect of the invention provides a three dimensional information carrier for information recording, comprising at least one embossed layer and a plurality of optically recorded layers forming a three dimensional lattice, the embossed layer being an integral part of the lattice.

Yet further aspect of the invention provides a three-dimensional carrier made of polymeric material having an embossed or optically recorded marks, wherein the carrier comprises a reinforcing carcass with a coating having magnetic coded servo marks.

The invention also provides a method of casting a three-dimensional optical information carrier. The method comprises carrying out the casting with an reinforcement carcass inserted in a casting form and polymer layers cast on both sides of the carcass being connected through holes in the carcass and converting the disc-like carrier into a truss-like structure, thereby significantly increasing the carrier resistance to bend and wobble.

According to yet another aspect of the invention, a method of assembly of a three dimensional information carrier is provided, the method comprising providing a carcass or a hub as an integral part of the carrier, said carcass or hub serving as assembly tools.

### BRIEF DESCRIPTION OF THE DRAWINGS

The disclosure is provided by way of non-limiting examples only, with reference to the accompanying drawings, wherein:

FIGS. 1A and 1B are illustrations of the first exemplary embodiment of a three-dimensional information carrier.

FIG. 2 illustrates the three dimensional lattice on nodes of which are located formatting marks.

FIG. 3 is a schematic illustration of the second exemplary embodiment of a three-dimensional information carrier.

FIGS. 4A and 4B are schematic illustrations of two examples of the third exemplary embodiment of a three-dimensional information carrier having a body including a plurality of monolithic plates.

FIGS. 5A-5L are illustrations of additional exemplary embodiments of a three-dimensional information carrier having a carcass.

FIGS. 6A-6C are schematic illustration of one of carcasses with through holes and the truss-like three-dimensional carrier structure produced by utilizing such a carcass.

FIG. 7 is a schematic illustration of a further embodiment of carrier with a reinforcing carcass.

FIG. 8 is a three dimensional illustration of the carcass of FIG. 7.

FIGS. 9A-9F are schematic illustrations of the fifth exemplary embodiment of a three-dimensional information carrier having a carcass.

FIGS. 10A-10I are schematic illustrations of the sixth exemplary embodiment of a three-dimensional information carrier.

FIG. 11 is a schematic illustration of a jig for assembly of a three-dimensional information carrier;

FIG. 12 is a schematic illustration of an improved gripper for non contact handling of plates of the three-dimensional information carrier;

FIG. 13 is a schematic illustration of the handling process of three-dimensional information carrier plates by the improved gripper;

### DETAILED DESCRIPTION OF THE INVENTION

The structure and principles of the carrier and the assembly method described thereby may be understood with reference to the drawings, wherein like reference numerals denote like elements through the several views and the accompanying description of non-limiting, exemplary embodiments. The drawings are not necessarily to scale, emphasis instead being placed upon illustrating the principles of the method.

Three-Dimensional Information Carrier

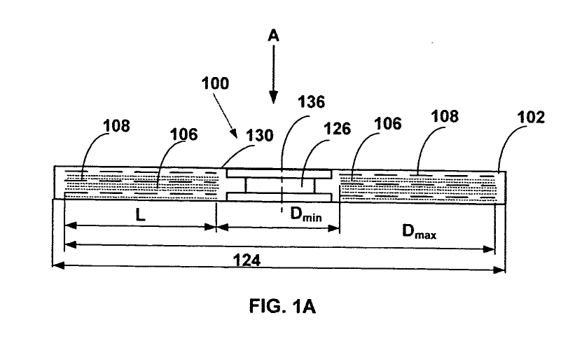

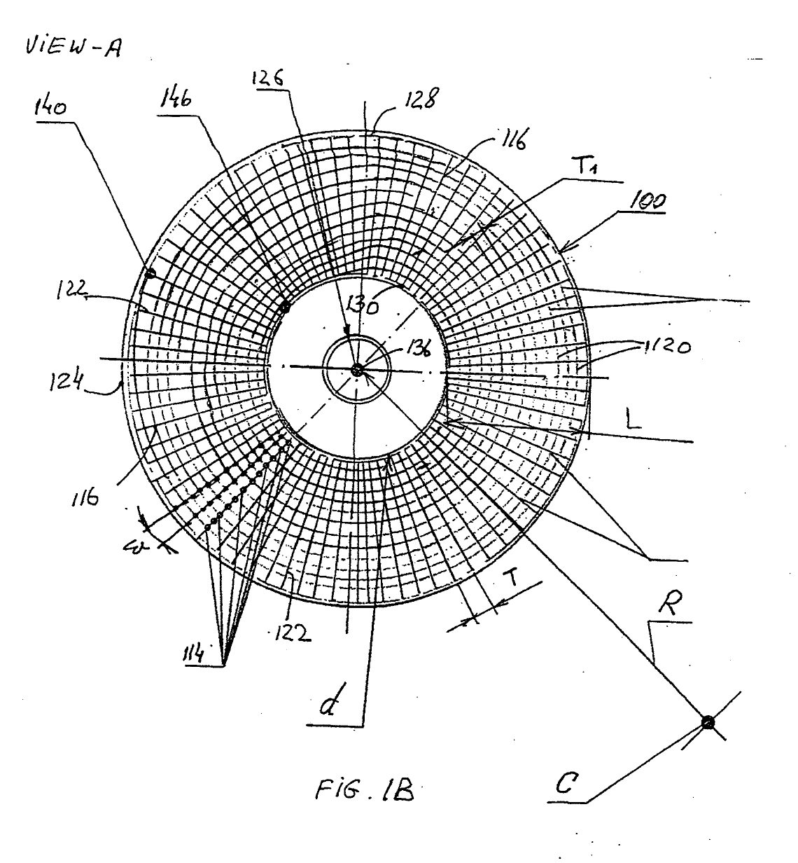

FIG. 1A is a cross section of the first exemplary embodiment of a three-dimensional optical information carrier. Carrier 100 may be a monolithic disc body made of a transparent or translucent material 102, for example a polymer material, such as Polymethylmethacrylate (PMMA) and compositions including acrylate and methacrylate monomers. An active moiety, capable of changing its state from one isomeric form to another upon interaction with electromagnetic energy, such as laser radiation, is bound to polymer 102. The active moiety exhibits two-photon absorption, and, as disclosed in Patent Convention Treaty Publication WO 03/070689 to the same assignee, could be used as a three-dimensional optical information carrier. The information is recorded on carrier 100 as series of three dimensional (3D) regular or oblong or oblong and tilted data marks such as ones disclosed in Patent Convention Treaty Publication WO 2005/015552 to the same assignee. Each record of the 3D mark or voxel may represent information, which may be a discrete 0 or 1.

The information is optically recorded on carrier 100 in practically any location, although it is convenient to record it on a plurality of “virtual” layers 106. The distance between layers 106 may be 10-15 micron. Thickness t of carrier 100 may vary between 1 and 6 mm. In addition to optically recorded regular or oblong or oblong and tilted data marks representing the information, a pattern of servo or formatting marks is optically recorded on carrier 100. Formatting marks are recorded on a plurality of layers 108 that may be located at different depths of carrier 100 and the formatting marks may be similar or sometimes identical to data marks, although the structure of layers 108 may be different from the structure of layers 106. One formatting or servo layer may be sufficient to provide coordinate information to a number of data containing layers 106. Accordingly, each formatting or servo layer 108 is interspaced by at least one data-containing layer 106.

Carrier 100 further features an external diameter 124 (FIGS. 1A and 1B); mounting bore 126 for mounting carrier 100 on a spindle of an optical recording/reading apparatus, a peripheral annular section 128 and an inner annular section 130. Typically, sections 128 and 130 are not utilized for recording data or servo marks, but may be used to record auxiliary information.

According to most of the standards, formatting marks are located on track spirals directed outwards or inwards, depending on the carrier rotation direction, beginning at the largest recordable dimension of an optical information carrier and ending at the smallest recordable dimension or vise versa. The track pitch T₁ (FIG. 1B), which is the distance between the centerlines of a pair of adjacent tracks measured in a radial direction may be about 800 nm. The typical distance T between two successive formatting marks 114 (which as exemplified in FIG. 1B are arranged in a spaced-apart locations at the intersections between spiral tracks and equidistantly angularly spaced radiuses 122) may be about 600 micron on the outer tracks and smaller on the inner tracks.

Tracks 120 begin at annular peripheral section 128 and end at inner annular section 130. Spiral tracks 120 represent a 360 degrees turn of a spiral materialized by a succession of pre-written marks recorded about the nominal center of spiral line. External diameter 124, inner diameter of mounting bore 126, and spiral tracks 120 have an essentially common rotation axis 136, which is the geometrical center of disc like information carrier body 100. The central intersection point of the equidistantly angularly spaced radiuses 122 coincides with the geometrical and rotation axes 136.

Analysis show that the number of formatting marks 114, which may be regular or oblong or oblong and tilted marks on each of spiral tracks 120 (FIG. 1B) of optical information carrier 100 would be equal to n₁=πD/T, where D is the track diameter and T is the distance between two successive symbols. Marks 114 are recorded on the active area of optical information carrier 100, which is bound by largest spiral track diameter Dₘₐₓ on which, for example at point 140 spiral track 120 begins and smallest spiral track diameter Dₘᵢₙ on which, for example at point 146 spiral track 120 ends. The width L of the active area would be L=(Dₘₐₓ−Dₘᵢₙ)/2. The number of spiral tracks for such a carrier would be n=L/T₁, where T₁ is the average pitch of the spiral tracks being about 1 micron. For a 120 millimeter external diameter carrier Dₘₐₓ would be about 117 mm and Dₘᵢₙ would be about 44 mm, which results in about 40,000 spiral tracks and about 25×10⁶ formatting marks.

If a radius 122 is traced from point 136, which is the rotation and geometric axis of carrier 100, to the largest diameter Dₘₐₓ of the spiral track it will intersect all spiral tracks existing on carrier 100. The number of intersections of a radius with the spiral tracks is equal to the number of tracks and would be n=L/T. A plurality of radiuses 122 exiting from point 136 may be traced and spaced such as to intersect each of formatting marks 114 residing on Dₘₐₓ, The angular increments ω of radiuses 122 may be selected such as to ensure that formatting marks 114 form a constant angular velocity servo pattern. The number of nodes or intersections points between the radiuses and spiral tracks is equal to the number of formatting marks present on carrier 100. The intersection points or nodes generated by the equidistantly spaced spiral tracks 120 and equiangular spaced radiuses 122 form a well-defined grid pattern. Accordingly, formatting marks 114 may be recorded about the nominal position of each of the nodes to form a constant angular velocity servo pattern. Other grid pattern, meeting the requirements of constant linear velocity or constant zonal velocity servo pattern may be provided.

Generally, use of arcs, instead of radiuses, that do not pass through the central intersection point is possible, although the positional error would be greater than for radiuses or radial arcs and the pattern of marks is more complicate.

Indeed as shown, in FIG. 1B formatting marks 114 are disposed on a grid the nodes 116 of which are generated by an intersection between equidistantly spaced spiral tracks 120 and equiangular spaced radiuses 122 or radial planes. As it was noticed, the regular or oblong or oblong and tilted formatting marks may be optically recorded on carrier 100 in any location, although it is convenient to record it on a plurality of layers 108. On each of layers 108, formatting marks 114 are disposed on a grid the nodes 116 of which are generated by an intersection between equidistantly spaced spiral tracks 120 and equiangular spaced radiuses 122.

Recorded formatting marks 114 form on carrier 100 a three dimensional lattice with axes being the radial mark position, angular mark position and position of the mark in the depth or what is called axial direction of carrier 100. FIG. 2 illustrates the three dimensional lattice with nodes 116. Formatting marks 114 are located about the nominal position of nodes 116. Accordingly, carrier 100 may be characterized in that formatting marks are disposed on a three dimensional lattice nodes. The nodes 116 of the lattice being intersections between equidistantly spaced (cylindrical) spiral tracks 120, equiangular spaced radial planes (radiuses) 122 and a plurality of recording planes 106 or 108 (virtual layers). The recording planes are orthogonal to the radial planes.

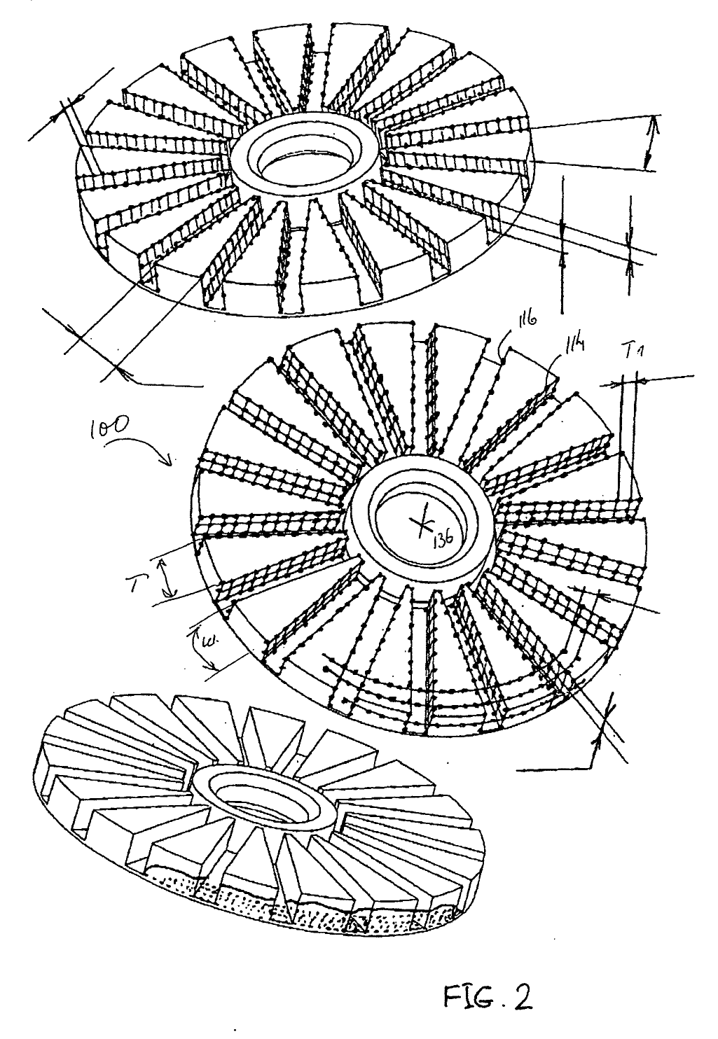

There is a well-known practice in the industry of providing a “blank” optical information carrier with one formatted layer. FIG. 3 is a schematic illustration of the second exemplary embodiment of a three-dimensional information carrier. Carrier 160 has an embossed servo pattern 164. Typically, such layer/pattern 164 is embossed or printed by any known in the art method on one of the carrier sides. This embossed servo pattern becomes a part or a reference, or basic layer of the three-dimensional lattice about nodes 168 of which optically recorded marks 172 will be located. The pitch of the embossed pattern and the distance between two adjacent marks define the pitch between the spiral tracks and the pitch between two adjacent optically recorded marks.

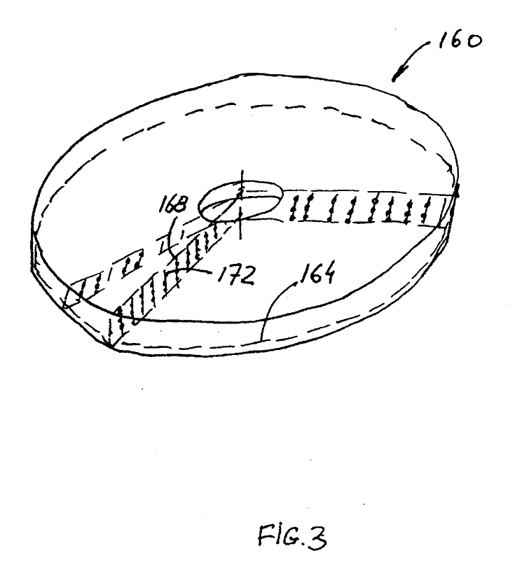

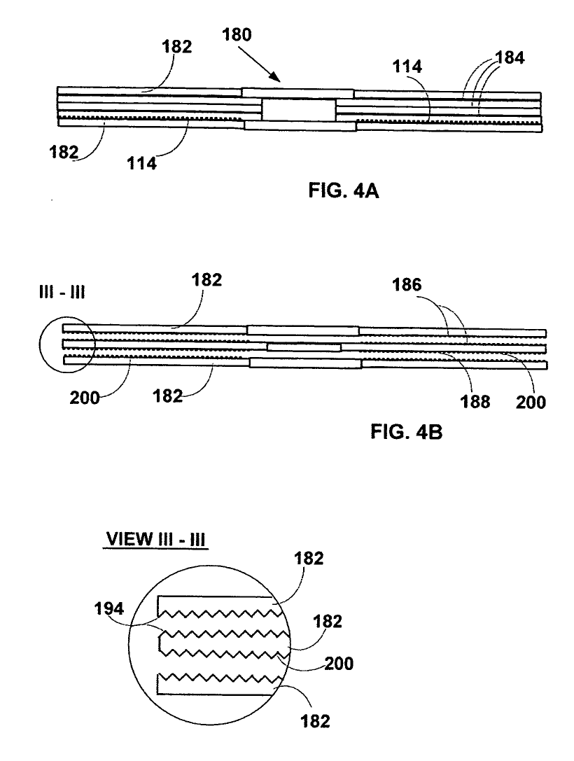

FIG. 4A is an illustration of the third exemplary embodiment of a three-dimensional information carrier 180. The monolithic body of carrier 100 is replaced by a plurality of attached to each other recordable, essentially monolithic plates 182 made of a transparent or translucent polymer material (102 in FIG. 1A). Plates 182 are produced separately as blocks of about 200 micron thickness or any other thickness convenient for processing, or as an assembly of thinner layers adhered to each other to form a group of suitable thickness. Each of plates 182 could as explained supra, bear at least one servo pattern 114 of formatting or servo marks. Alternatively, each of plates 182 may bear an embossed or printed servo pattern produced by any known in the art method. The method of assembly of the plates will be explained below.

Transparent adhesive 184 that contains an active moiety may attach plates 182 to each other. Adhesive 184 fills-in the embossed marks of pattern 164 (FIG. 3). The active moiety is responsible to electro-magnetic or laser radiation and it changes its state from one isomeric form to another upon interaction with electromagnetic (laser) energy. Since the proportion of the active moiety in adhesive 184 may be different from the one in the material of plates 182, marks of pattern 164 respond to the appropriate laser radiation in a different way than information marks recorded in the volume of plates 182. This allows easy discrimination between the servo marks and recorded information marks. The servo marks may be of any form and size listed above.

In an alternative embodiment, disc like plates 182 (FIG. 4B) may have impressed on one of the flat surfaces 186 or 188 a micro relief 194 containing guiding or formatting symbols 200 that may serve as servo symbols or marks. The micro relief may also serve as a guiding and fixing feature for the assembly of plates 182. When plates 182 are assembled into a carrier body, micro relief symbols become disposed on a three-dimensional lattice, and each of symbols has defined coordinates in the lattice and each symbol has defined coordinates in a two dimensional plane, which may be a recording plane. Transparent adhesive 184 that attaches plates 182 to each other fills-in the micro relief and accordingly symbols 200 and allow easy discrimination between the servo symbols and recorded information marks. Symbols 200 that typically are servo marks may be substantially larger than regular data or formatting marks.

Polymer material (102 in FIG. 1A) of the carrier body defines the physical support and durability to optical information carrier 100. Polymer 102 does not possess proper mechanical strength required for high rotational speed. High rotational speed might cause irreparable mechanical damage to optical discs. Increase of rotational speed is however imperative for high capacity information carriers.

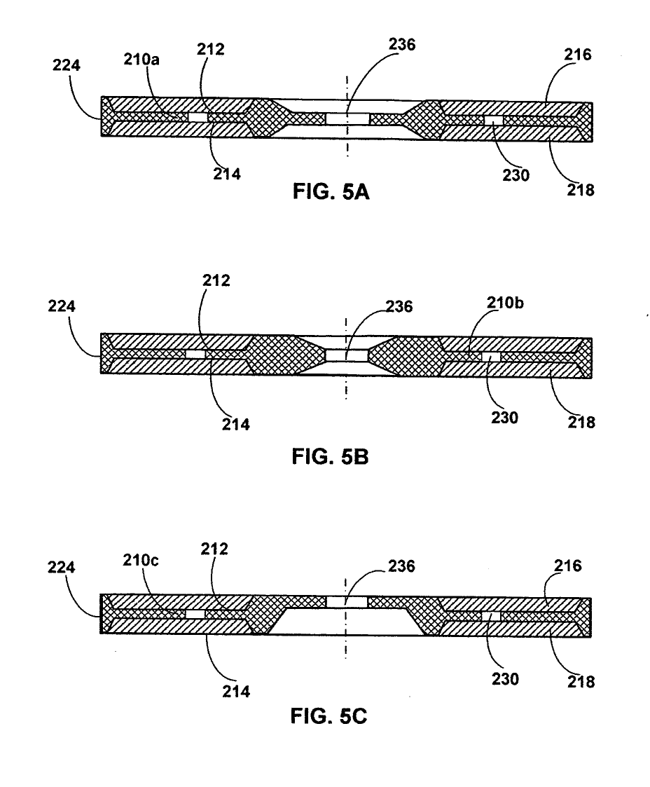

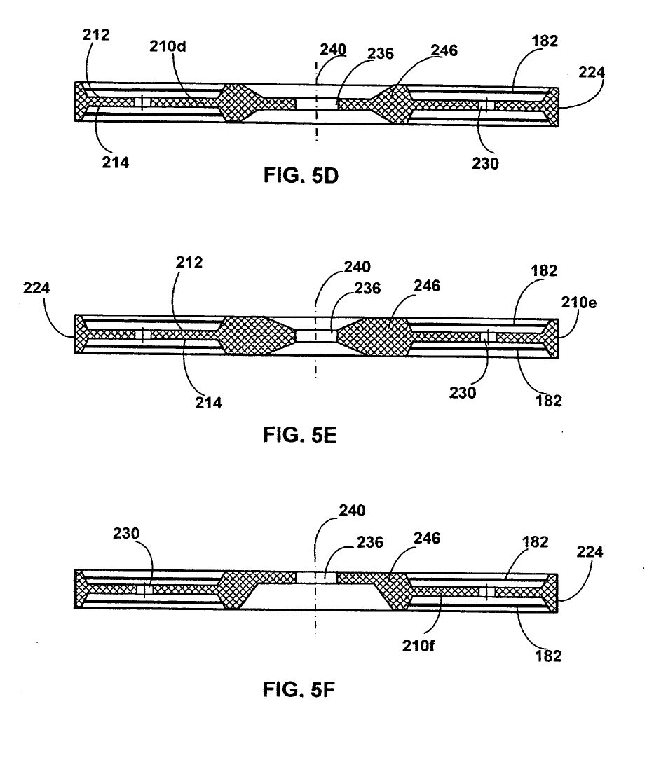

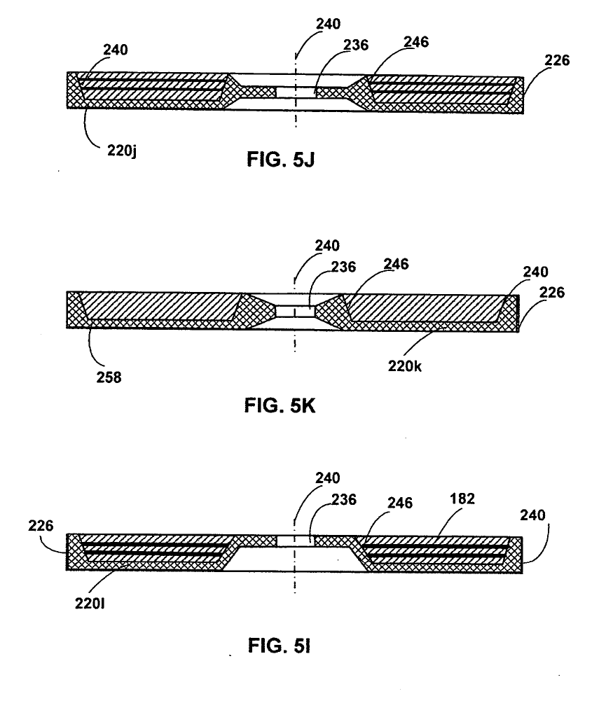

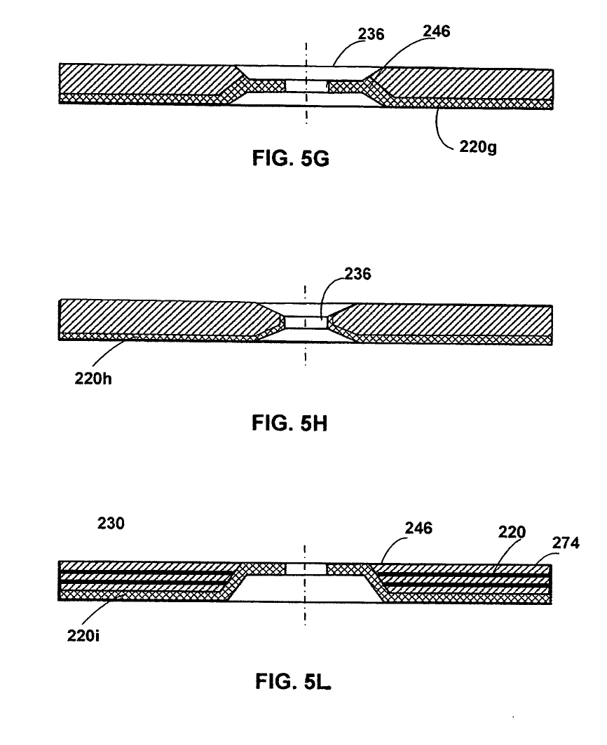

FIGS. 5A-5L illustrate the forth embodiment of a three-dimensional optical information carrier. Carriers of FIGS. 5A-5L have a reinforcing carcass. Carcass 210a-210f may be a symmetric internal carcass (FIGS. 5A through 5F). Carcass 220g-220l is an asymmetric external carcass (FIGS. 5G through 5L). Metal, plastic or composite materials are different stronger than polymer 102 materials of which reinforcing carcasses 210a-210f and 220g-220l may be produced. For example, the carcasses may be made of beryllium, which has superior stiffness and does not distort even at such high rotational speeds as 45,000 rpm.

Use of any type of reinforcing carcasses made of materials having higher strength than polymer 102 of which the recordable layers are made supports rotation of the information carrier at a speed substantially higher than carriers that do not have such reinforcing carcass. Reinforcing carcass reduces or eliminates carrier mechanical deformations caused by centrifugal forces that act on the rotating carrier. Rotational speeds exceeding 10,000 rpm are obtained.

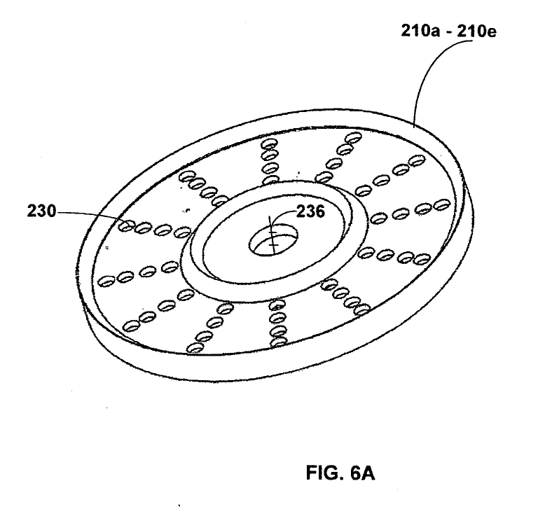

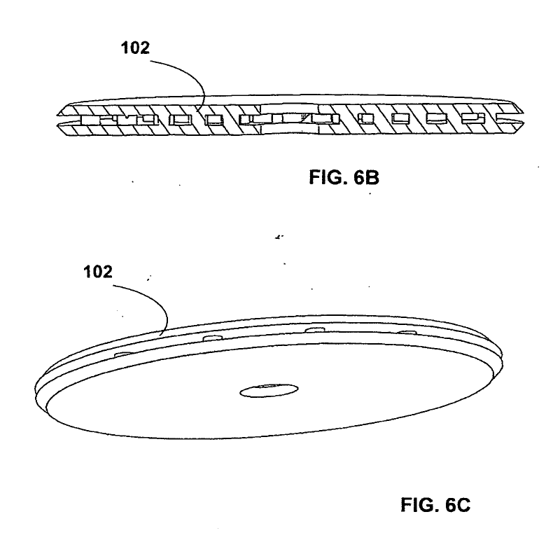

FIGS. 5A through 5F illustrate some examples of a three-dimensional information carrier with symmetric carcasses having recordable medium 102 disposed on both sides of carcass (denoted 210a-210f in FIGS. 5A-5F, respectively). In these examples, both sides 212 and 214 of carcasses are in contact with monolithic polymeric bodies 216 and 218 or with bodies assembled of disc like plates 182 (FIGS. 5D-5F). Carcasses 210a-210c, as illustrated in FIGS. 5A-5C, have a plurality of through holes 230 disposed on the surface of carcass as illustrated in FIGS. 6A-6C. Monolithic polymeric material 102 forming the carrier body or at least one of plates 182 are cast simultaneously into a form containing carcass. Polymeric material 102 penetrates through holes 230 and connects plates disposed on both sides of the carcass. This method of production, as illustrated in FIGS. 6B and 6C, converts the disc-like carrier into a truss-like structure and significantly increases the three-dimensional carrier resistance to bend, wobble and fracture. For the simplicity of explanation the truss-like structure in FIGS. 6B and 6C is shown without carcass.

Embossed or printed formatting layers may be also used in cases where plates 182 are cast or pressed separately and transparent adhesive or adhesive material 184 is used to attach them to the carcass.

Carcasses 210a-210e may have on their flat surfaces 212 and 214, that are in contact with polymeric bodies 216 and 218 (FIGS. 5A-5C) or with plates 182 (FIGS. 5D-5E), embossed servo marks or test and guiding symbols, similar to symbols 200 (FIG. 4B) that may serve as servo symbols or marks. Symbols similar to symbols 200 represent a micro relief impressed on surfaces of carcasses 210a-210e. The micro relief may serve as a guiding and position-fixing feature for the assembly of plates 182. Transparent adhesive (184 in FIG. 4A) that contains an active moiety in a proportion different of the one of polymeric bodies 216 and 218 may fill-in the micro relief and adhere polymeric bodies 216-218 to carcasses 210a-210e. The principles of operation of these symbols are similar to the described above embodiments. Symbols 200 may indicate axial and radial position the guiding or servo laser beam. This provides at least one reference servo layer that may be utilized for optically writing additional servo layers located in different layers disposed within the 3D carrier.

Similar to the earlier embodiment the embossed servo pattern becomes a part or the first or basic layer of three-dimensional lattice about nodes 168 of which optically recorded marks 172 (FIG. 3) will be located. The embossed pattern defines the pitch between the spiral tracks and the pitch between two adjacent marks. In a similar manner, the marks of the embossed pattern of carrier 210e-210f may be filled in by transparent adhesive 184 that contains an active moiety having a proportion of active ingredient different from the proportion of active moiety in material 102 of monolithic body 100.

FIGS. 5G-5L illustrate three-dimensional carriers with asymmetric carcasses, denoted respectively 220g-220l, to which a monolithic polymeric body is attached by different means. FIGS. 5I, 5J and 5L illustrate asymmetric carcasses to which a polymeric body assembled of disc like plates 182 is attached. Carcasses 220j-220l have a rim with conical inner surfaces 240 and 246. Different symbols embossed or engraved on these surfaces may be used for determination of the axial location of the laser beam.

Carcasses 210d-210f and 220i-220l have hub like inner parts with outer conical surfaces 246. These conical surfaces may serve as a centering feature for the assembly of disc like plates 182. Carcasses 210a-210f and 220i-220l serve as a base for assembly of monolithic polymeric bodies or disc like plates 182. All described above properties of the carriers, like location of the marks about the nodes of a three dimensional lattice, transparent adhesive 184 and others are mutatis mutandis applicable to all embodiments described.

Outer diameter surfaces 224 and 226 of carcasses 210a-210f and 220g-220l of three-dimensional information carriers may be used for placement on them marks, symbols or alphanumeric characters identifying for example manufacturer, batch number etc. Alternatively, the marks may be used for reading angular rotation speed, coordinates of a specific location on the information carrier etc.

The reinforcing carcass may be produced of a composite material that consists of metal nano spheres having a magnetic nucleus, for example those commercially available from MPI Metal Powder Industries Ltd., Beer-Sheba, Israel. Such a carcass provides a convenient way of making a magnetic coded servo combined with optical recording means. Alternatively, a magnetically recordable coating may be deposited on the relevant side of the carcass or on the polymer material of which optical information carrier is made.

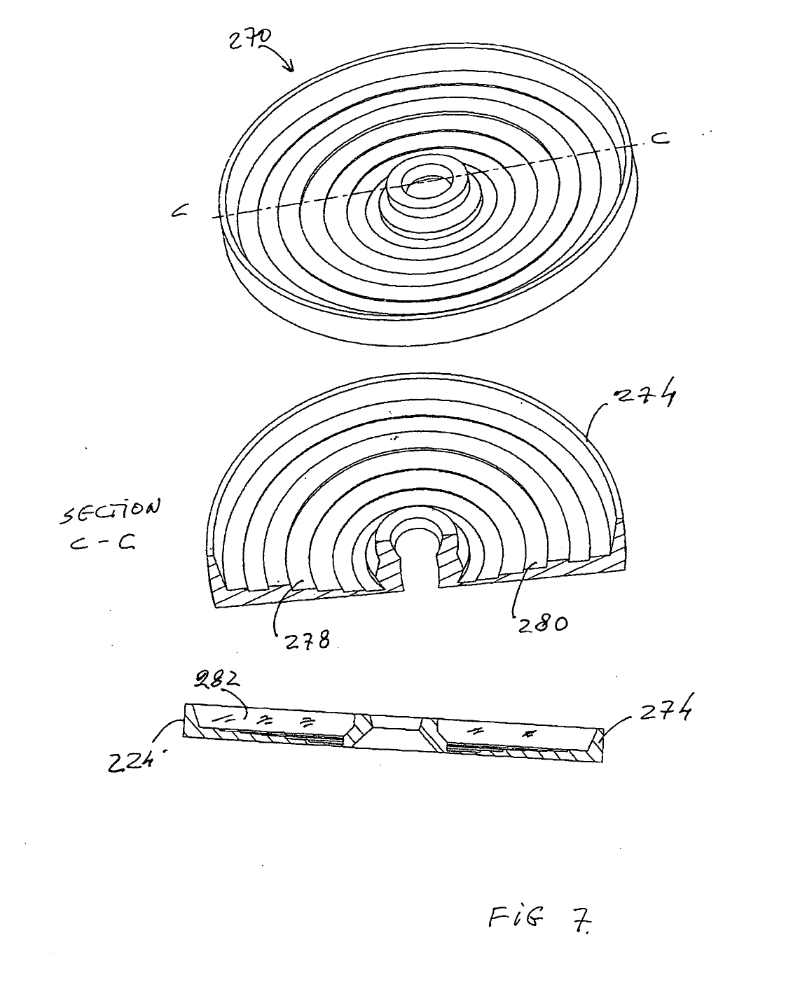

FIG. 7 is an illustration of a carrier 270 that has a carcass 274 with a step like surface 278. Accordingly, the contact surface 280 of monolithic material 282 or assembled from disc-like plates body (not shown) has matching contact surface. Use of step like surface enables easier coarse laser beam location determination.

FIG. 8 is a three dimensional illustration of the carcass of FIG. 7. Symbols 282 impressed on each of the steps of step like surface 278 may have different pitch and may be shifted with respect to the previous surface symbols. This simplifies determination of the position of any of the participating in the guiding, recording, reading or erasing laser beams. All of the properties and features of symbols 200 described above are mutatis mutandis applicable to symbols 282.

All carcasses illustrated above have their central part implemented in a hub-like form. Hubs provide convenient and highly accurate carrier mounting means. The three-dimensional carriers are planed for multiple and long term use. Hubs, being made of material stronger than the carrier body material, improve the durability of the mounting elements of the carrier. The conical surfaces of the hubs may be used as assembly jigs or tools for assembly of plates of which the carrier is produced. The external diameters of the carcasses 210a-210f and 220g-220l, inner diameter of mounting bores 236, and spiral tracks have a common rotation axis 240, which is the geometrical center of disc like information carriers.

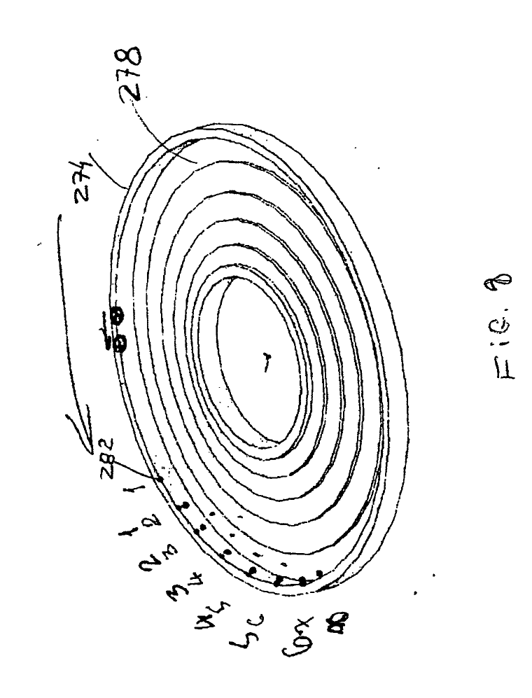

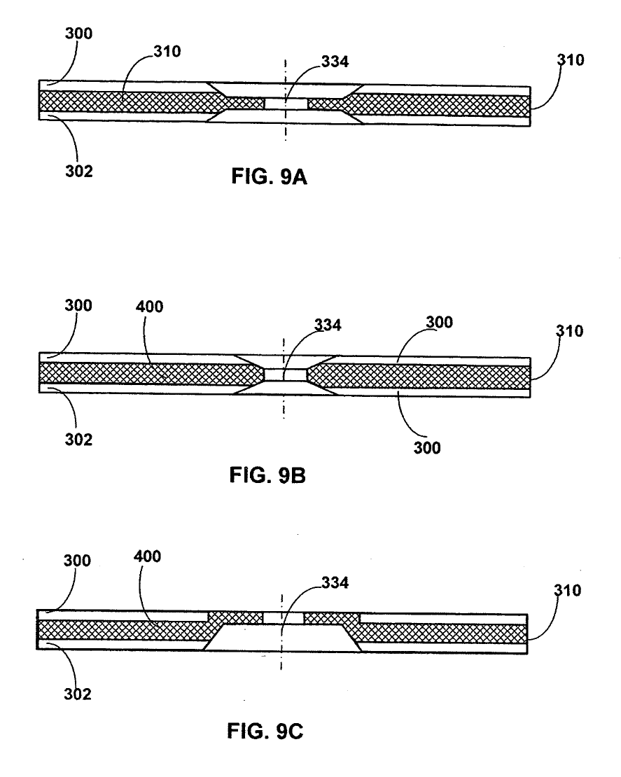

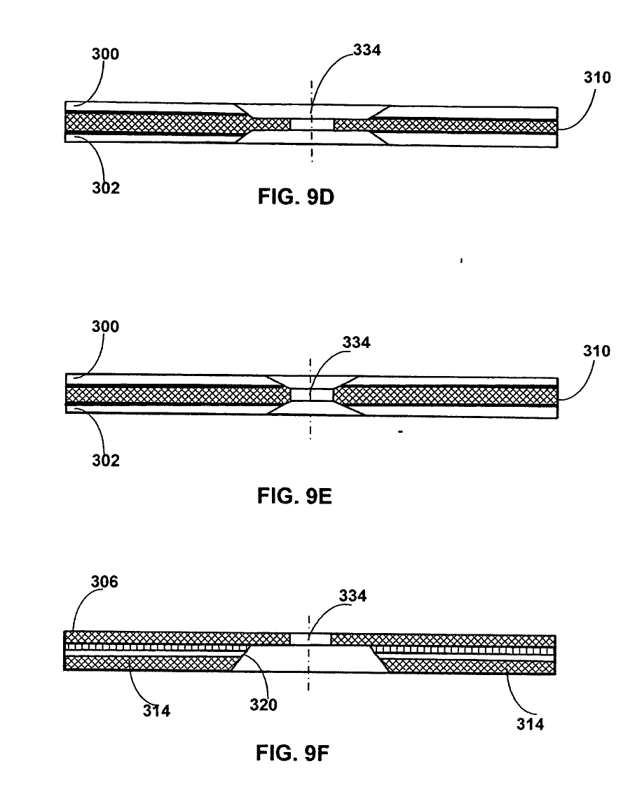

FIGS. 9A through 9F are illustrations of some exemplary embodiments of a three-dimensional information carrier with an external symmetric reinforcing carcass. Carcasses 300, 302 (FIGS. 9A-9E) and 306 (FIG. 9F) are of a disc like shape and made of a transparent material, for example polycarbonate, that is stronger than polymeric material 102 of monolithic body, designated here 310, 400, 314. A micro relief, similar to the one disclosed above, is impressed/embossed on one of the sides of carcasses 300, 302 and 306. Carriers of FIGS. 9A-9C are produced by casting with carcasses 300 and 302 inserted in the casting form. Alternatively, a regular adhesive or such as adhesive 184 attaches carcasses 300 and 302 to carriers of FIGS. 9D-9F. Uses of a symmetric carcass creates a strong truss-like bending and wobble resisting structure of the three-dimensional information carrier and supports conducting guiding, recording, reading and erasing processes from both sides of the carrier.

All properties and features of symbols 200 filled in by adhesive 184 are mutatis mutandis applicable to micro relief/symbols impressed on surfaces of carcasses 300, 302 and 306. Symbols 200 may serve as a reference layer for optically recorded formatting layers with formatting marks being disposed about the nodes of a three dimensional lattice similar to the earlier disclosed lattice.

FIG. 9F illustrates an embodiment where one transparent carcass 306 is used. Carcass 306 may be attached to a monolithic body 314 directly or with the help of an intermediate disc like plate 320. A micro relief bearing formatting symbols may be embossed on carcass 306 or on disc like plate 320. Adhesive 184 facilitates carcass to monolithic body attachment. All carcasses and associated with them polymeric bodies of FIGS. 9A-9F are centered on three-dimensional carrier rotational axis 334.

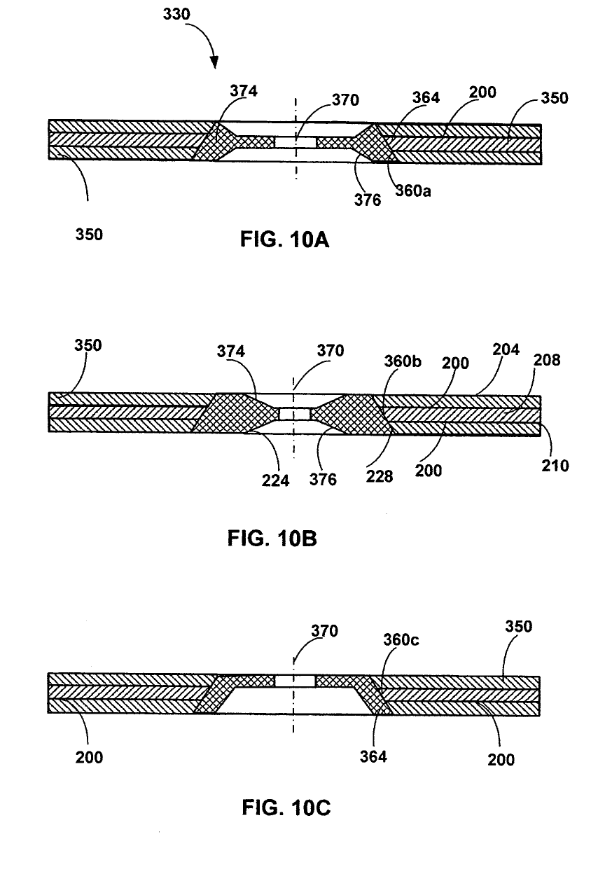

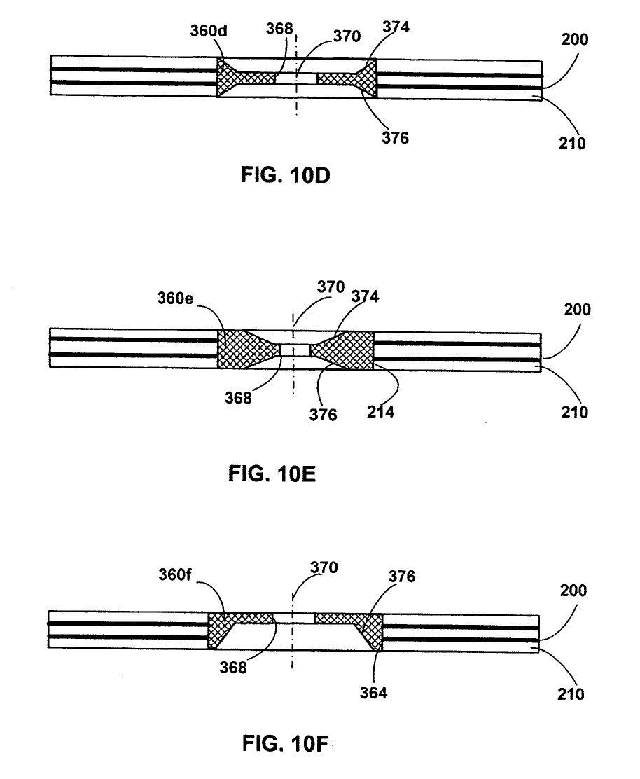

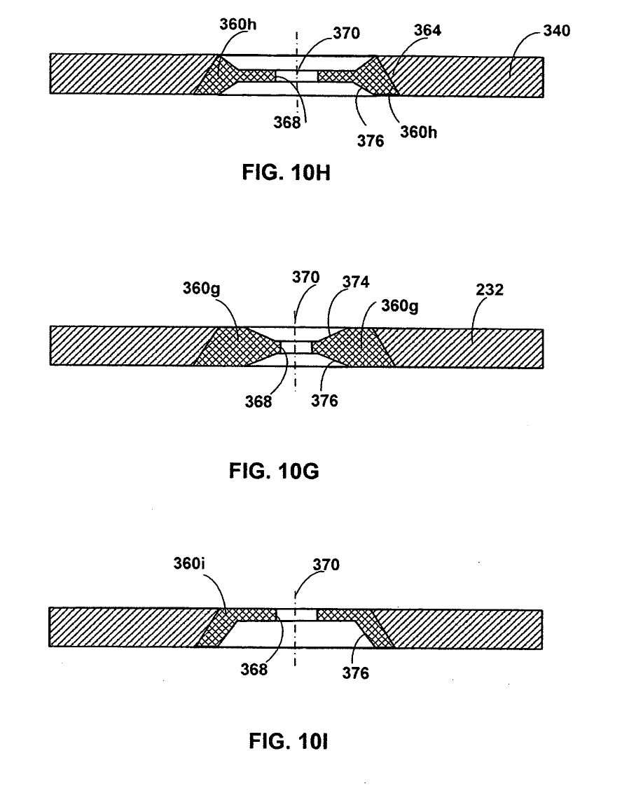

FIGS. 10A-10I are schematic illustrations of the sixth exemplary embodiment of a three-dimensional information carrier. In the examples of FIGS. 10A-10C, plates 350 are assembled on hubs 360a-360c, respectively. Conical surfaces 364 of hubs 360a-360c engage a matching surface of inner circumference and centers disc like plates on common axis 370, which is the rotational axis of three-dimensional carriers 330. Hubs 360a-360c serve as assembly jigs/tools. In addition to this, conical surface 364 may be used, as explained before for rough laser beam position feedback and orientation.

Disc like plates 350 may have at least on one of their surfaces micro relief that contains test and guiding symbols 200 that may serve as servo symbols or marks. The micro relief may serve as a guiding and disc position-fixing feature for the assembly of plates 350. When plates 350 are assembled into a carrier body micro relief symbols 200 become disposed on a three dimensional lattice, and each of symbols 200 has defined coordinates in the lattice and each of symbols 200 has defined coordinates in a two dimensional plane, which may be a recording plane.

Transparent adhesive 184 that attaches plates 350 fills-in the micro relief and accordingly symbols 200. Symbols 220 may indicate axial and radial position of the guiding or servo laser beam. Guiding symbols 200 may be substantially larger than the optically recorded information marks. Although being on the same three-dimensional lattice, the number of symbols 200 in each of the layers may be different, and missing symbols may indicate on particular layer axial location. All hubs 360a-360i, their mounting bores 368 and associated with them polymeric bodies of FIGS. 10A-10I are centered on the three-dimensional carrier rotational axis 370.

Carriers of FIGS. 10H-10I may be cast with hubs 360h-360i inserted in the casting form. Hubs made of material more stable (metal for example) than the polymeric material, improve the casting accuracy and produce a carrier with reduced wobble and outer surfaces run-out. All hubs 360 have on both of their sides conical troughs 374 or 376. These troughs simplify the casting form assembly/disassembly and facilitate use of hubs 360 in the casting process.

Method of Handling and Assembly of Plates of Recordable Material

As mentioned above, plates 182 made of polymer material 102 are produced separately. Carcasses 210a-210l, as shown in FIGS. 5A-5L, and hubs 360a-360i (FIGS. 10A-10I) may serve as a jig and facilitate the assembly process. Proper facilities for IR curable material and IR curing sources should be provided.

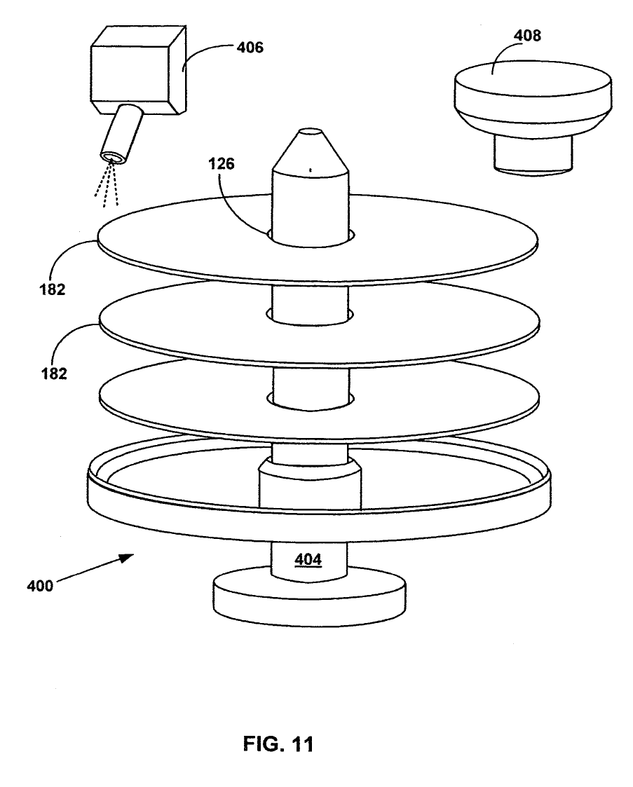

Assembly of plates 182 or similar into a carrier requires special jigs such as the one shown in FIG. 11. Jig 400 for assembly of plates 182 includes a base plate 402 on which a post 404, having an accurate outside diameter matching the mounting bore 126 inner diameter, is mounted. A dispenser 406 dispenses a regular IR curable adhesive (or adhesive 184) such that it covers by an even layer the surface of the preceding plate 182. Next plate 182 is overlaid and cured by thermal radiation provided by a source of IR radiation 408 or a ceramic heater. The flux provided by IR source 408 is appropriately controlled to illuminate the curable surfaces by an evenly distributed radiation. The IR flux may be provided from one or both sides of the assembly.

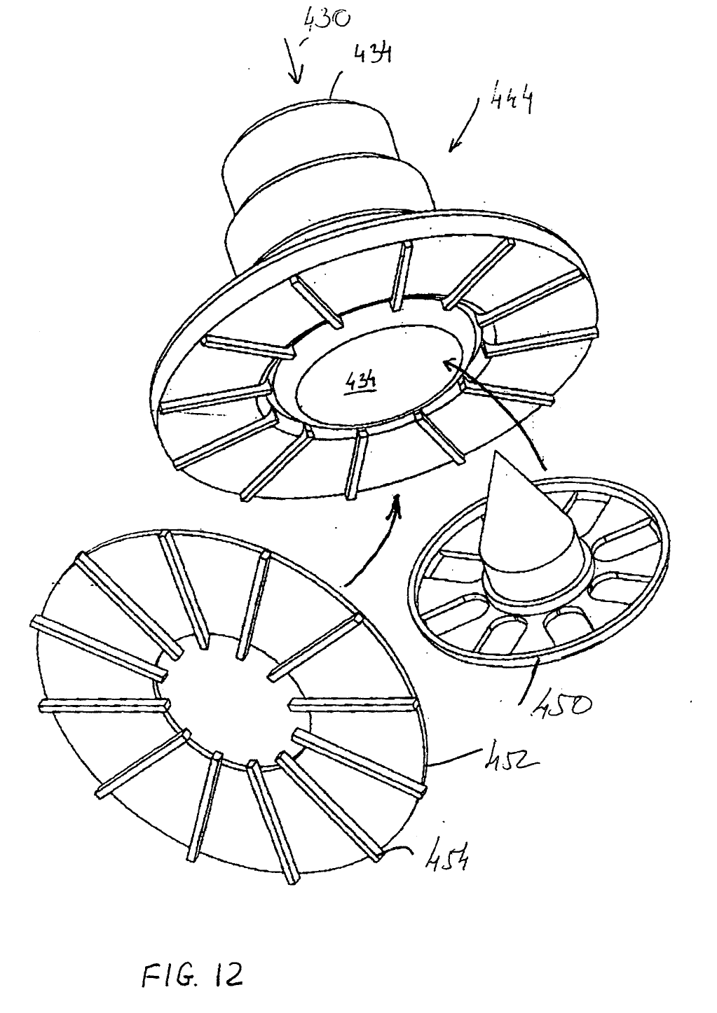

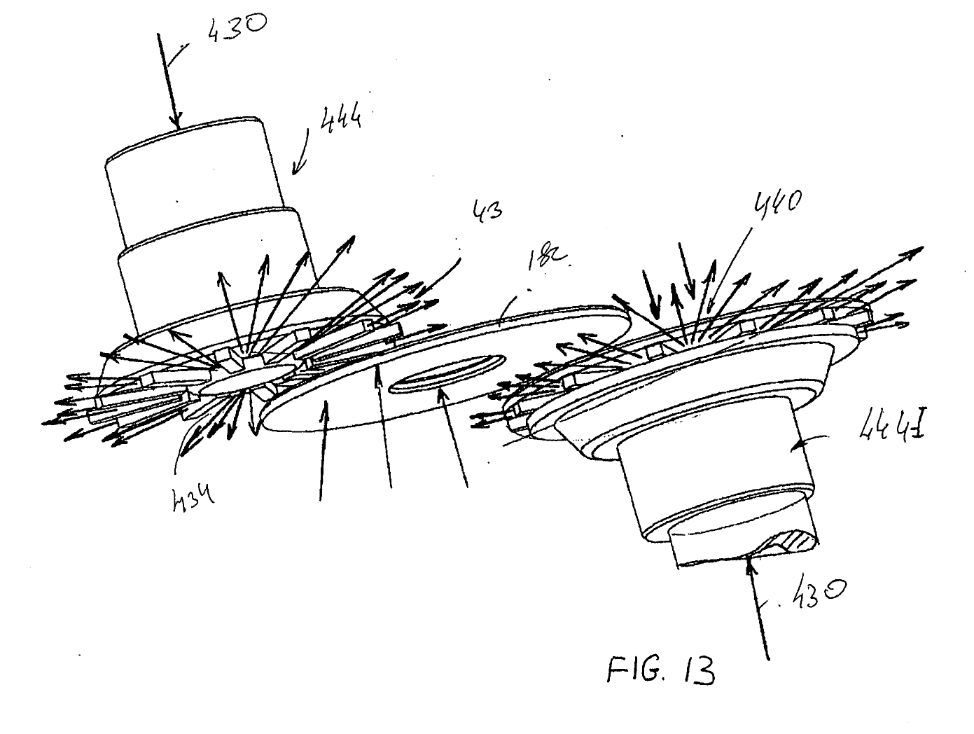

Polymer material (previously referred to as 102) is a delicate one and contact handling of plates 182 of material 102 may leave on it scratches, pits and other symbols that may complicate recording or reading processes. Use of pick-up heads or grippers for non-contact objects handling is known in the art. One example of such pick-up head or gripper are disclosed in U.S. Pat. No. 5,871,814 to Livshits. The gripper is however not adapted for handling of parts having a bore in their central region. An improved version of the above gripper is shown in FIG. 12. A fluid flow 430, for example air, introduced into a passageway 434 creates a pressure below atmospheric at the output part 440 (FIG. 13) of gripper 444. The improved version includes improved conical fluid shaping means 450 disposed in the passageway in fluid communication with the inlet for changing the shape of the fluid flow into a planar fluid flow flowing radial outwardly from a central point and an improved disk 452 having flow homogenizing dissectors 454. These improvements create a better vacuum adjacent to the disk surface and hold in a more reliable manner objects having a central bore.

FIG. 13 illustrates plate 182 or a similar item handling by grippers 444. When fluid flow 430 is activated, gripper 444 develops a pressure below atmospheric at the output part 434 of it. Gripper 444 picks up plate 182 from plate production line and delivers it to the assembly station which may be a station such as jig 400 (FIG. 11) or carcass 210a-210f or hub 360a-360i. If necessary the orientation of plate 182 may be changed with the help of a second gripper 444-I. Regulating the fluid flow through each of grippers 444 and 444-I regulates the vacuum they develop and accordingly the force that holds plate 182.

While the exemplary embodiment of the present method have been illustrated and described, it will be appreciated that various changes can be made therein without affecting the spirit and scope of the method. The scope of the method, therefore, is defined by reference to the following claims:

1. A three dimensional optical information carrier, comprising formatting marks disposed on the nodes of a three dimensional lattice formed by the intersection of equiangular spaced radial planes, equidistantly spaced cylindrical spiral tracks and virtual recording planes.

2. The carrier of claim 1, wherein the body of the carrier includes at least one of a monolithic body and an assembly of monolithic plates.

3. The carrier of claim 2, wherein the body of the carrier contains an active moiety that is responsive to electromagnetic radiation.

4. The carrier of claim 1, wherein the formatting marks include at least one of the following types: regular, oblong, oblong and tilted marks.

5. The carrier of claim 1, wherein the formatting marks are responsive to electromagnetic radiation.

6. The carrier of claim 1, wherein at least one layer of formatting marks and symbols is generated by micro relief impressed on at least one flat side of the plates.

7. The carrier of claim 6, wherein each of the marks and symbols has defined coordinates in the lattice and each mark and symbol has defined coordinates in a two dimensional recording plane.

8. The carrier of claim 6, wherein the micro relief is configured to serve as guiding and position fixing feature for the assembly of the plates.

9. The symbols of claim 7, wherein the formatting symbols are substantially larger than information marks.

10. A three dimensional optical information carrier having a body made of polymeric material, and comprising a reinforcing carcass supporting the body of the carrier, said carcass being made of material different from the body of the carrier and being an integral part of the carrier.

11. The carrier of claim 10, wherein the body of the carrier includes at least one of a monolithic body and an assembly of monolithic plates.

12. The carrier of claim 11, wherein the body of the carrier contains an active moiety that is responsive to electromagnetic radiation.

13. The carrier of claim 10, wherein formatting marks formed in the carrier are disposed on the nodes of a three dimensional lattice formed by the intersection of equiangular spaced radial planes, equidistantly spaced cylindrical spiral tracks and virtual recording planes.

14. The carrier of claim 10, wherein the marks include at least one of the following types: regular, oblong and oblong and tilted marks.

15. The carrier of claim 10, wherein the marks are responsive to electromagnetic radiation.

16. The marks of claim 14, wherein the formatting marks are substantially larger than information marks.

17. The carrier of claim 10, wherein the reinforcing carcass is made of at least one of the following materials: metal, plastic, composite material and metal-coated plastic.

18. The carrier of claim 10, wherein a micro relief impressed on at least one flat side of the carcass generates a reference layer of formatting marks and symbols.

19. The carrier of claim 18, wherein the micro relief serves as guiding and position fixing feature for assembly of the plates.

20. A three dimensional optical information carrier having a body made of polymeric material, and comprising a reinforcing carcass supporting the body of the carrier, said carcass being made of material different from the body of the carrier, and comprising formatting marks made in the body of the carrier and being disposed on the nodes of a three dimensional lattice formed by the intersection of equiangular spaced radial planes, equidistantly spaced cylindrical spiral tracks and virtual recording planes.

21. The carrier of claim 20, wherein the body of the carrier includes at least one of a monolithic body and an assembly of monolithic plates.

22. The carrier of claim 20, wherein the body of the carrier contains an active moiety that is responsive to laser radiation.

23. The carrier of claim 20, wherein the marks include at least one of the following types: regular, oblong, oblong and tilted marks.

24. The carrier of claim 20, wherein the marks are responsive to electromagnetic radiation.

25. The marks of claim 23, wherein the formatting marks are substantially larger than information marks.

26. The carrier of claim 20, wherein the reinforcing carcass is made of at least one of the following materials: metal, plastic, composite material and metal-coated plastic.

27. The carrier of claim 20, wherein a micro relief impressed on at least one flat side of the carcass generates a reference layer of formatting marks and symbols.

28. The carrier of claim 27, wherein the micro relief serves as guiding and position fixing feature for assembly of the plates.

29. A three dimensional optical information carrier having a body made of polymeric material, and comprising a central hub, which is made of material different from the body of the carrier, is an integral part of the carrier, and serves as the carrier mounting facility, and comprising formatting marks made in the body of the carrier and being disposed on the nodes of a three dimensional lattice formed by the intersection of equiangular spaced radial planes, equidistantly spaced cylindrical spiral tracks and virtual recording planes.

30. The carrier of claim 29, wherein the hub is made of at least one of the following materials: metal, plastic and composite material.

31. A three dimensional multilayer optical information carrier comprising an assembly of plates containing an active moiety, the plates being attached to each other by an adhesive containing a proportion of active moiety different from the one contained in the plates.

32. The carrier of claim 31, wherein the plates have a micro relief on at list one of the surfaces.

33. The carrier of claim 32, wherein the adhesive containing a proportion of active moiety different from the one contained in the plates fills-in the micro relief.

34. The carrier of claim 32, wherein the micro relief includes marks and symbols serving as formatting marks.

35. The carrier of claim 34, wherein the marks and symbols include at least one of the following: regular, oblong and oblong and tilted marks.

36. The carrier of claim 35, wherein the formatting marks are substantially larger than information marks.

37. The carrier of claim 31, wherein a micro relief impressed on at least one flat side of the carcass generates a reference layer of formatting marks and symbols.

38. A three dimensional multilayer optical information carrier comprising an assembly of plates containing an active moiety, the plates being attached to each other by an adhesive containing a proportion of active moiety different from the one contained in the plates, and comprising a central hub made of material different from the body of the carrier and serving as the carrier mounting facility.

39. The carrier of claim 38, wherein the hub is made of at least one of the following materials: metal, plastic and composite material.

40. The carrier of claim 38, wherein the plates have a micro relief on at list one of their surfaces.

41. The carrier of claim 40, wherein the adhesive containing a proportion of active moiety different from the one contained in the plates fills-in the micro relief.

42. The carrier of claim 40, wherein the micro relief includes marks and symbols serving as formatting marks.

43. The carrier of claim 42, wherein the marks include at least one of the following types: regular, oblong and oblong, and tilted marks.

44. The carrier of claim 43, wherein the formatting marks are substantially larger than information marks.

45. The carrier of claim 40, wherein the micro relief impressed on at least one flat side of the carcass generates a reference layer of formatting marks and symbols.

46. A three dimensional multilayer optical information carrier comprising an assembly of plates containing an active moiety, the plates being attached to each other by an adhesive containing a proportion of active moiety different from the one contained in the plates, and comprising formatting marks made in the body of the carrier and being disposed on the nodes of a three dimensional lattice formed by the intersections of equiangular spaced radial planes, equidistantly spaced cylindrical spiral tracks and virtual recording planes.

47. The carrier of claim 46, wherein the plates have a micro relief on at list one of the surfaces.

48. The carrier of claim 47, wherein the adhesive containing a proportion of active moiety different from the one contained in the plates fills-in the micro relief.

49. The carrier of claim 47, wherein the micro relief includes marks and symbols serving as formatting marks.

50. The carrier of claim 49, wherein the marks include at least one of the following types: regular, oblong, oblong and tilted marks.

51. The carrier of claim 49, wherein the formatting marks are substantially larger than information marks.

52. A three dimensional multilayer optical information carrier comprising: a body formed by an assembly of plates containing an active moiety, the plates being attached to each other by an adhesive containing a proportion of active moiety different from the one contained in the plates; and comprising a reinforcing carcass supporting the plates and being made of material different from the plates; and formatting marks made in the body of the carrier and being disposed on the nodes of a three dimensional lattice formed by the intersection of equiangular spaced radial planes, equidistantly spaced cylindrical spiral tracks and virtual recording planes.

53. A three dimensional optical information carrier, comprising a rotational axis and a polymeric body with bound to it active moiety, and comprising an enforcement carcass at least partially supporting the body, the body and the carcass being centered around said rotational axis.

54. The carrier of claim 53, wherein the body further comprises a micro relief that includes test and guiding symbols and the symbols serve as a reference formatting layer for optically recorded formatting marks, and further characterized in that all marks and symbols are disposed on a three dimensional lattice, and each of the symbols has defined coordinates in the lattice and each symbol has defined coordinates in a two dimensional recording plane.

55. The carrier of claim 53, wherein said body is formed by plates adhered to each other by a transparent adhesive containing an active moiety having a proportion of active material different from the one the body has.

56. The carrier of claim 55, wherein the symbols are filled-in by the adhesive.

57. A three dimensional information carrier for information recording, comprising oblong and tilted, optically recorded formatting marks disposed on a three dimensional lattice nodes, the nodes being an intersection between equidistantly spaced spiral tracks, equiangular spaced radial planes and a plurality of recording planes, the recording planes being orthogonal to the radial planes.

58. The carrier of claim 57, wherein the carrier comprises a disc like body including at least one of the following: a monolithic carrier, plurality of recordable plates assembled on a reinforcing carcass, and a plurality of recordable plates adhered between them.

59. A three dimensional information carrier for information recording, comprising at least one embossed layer and a plurality of optically recorded layers forming a three dimensional lattice, the embossed layer being an integral part of the lattice.

60. A method of casting a three-dimensional optical information carrier, that the method comprising: carrying out the casting with an reinforcement carcass inserted in a casting form and polymer layers cast on both sides of the carcass being connected through holes in the carcass and converting the disc-like carrier into a truss-like structure, thereby significantly increasing the carrier resistance to bend and wobble.

61. A three-dimensional carrier made of polymeric material having an embossed or optically recorded marks, and comprising a reinforcing carcass with a coating having magnetic coded servo marks.

62. A method of assembly of a three dimensional information carrier, the method comprising providing a carcass or a hub as an integral part of the carrier, said carcass or hub serving as assembly tools.

63. The method of assembly of claim 62, wherein a micro relief is impressed on at least one surface of plates, forming the body of the carrier, and serves as guiding and position fixing feature.
